(19) United States
(12) Patent Application Publication
(10) Pub. No.: US 2018/0237012 A1
(43) Pub. Date: Aug. 23, 2018

(54) AUTONOMOUS VEHICLE TOWING

(71) Applicant: Ford Global Technologies, LLC, Dearborn, MI (US)

(72) Inventors: Hassene Jammoussi, Canton, MI (US); Fakhreddine Landolsi, Canton, MI (US); Pankaj Kumar, Dearborn, MI (US); Imad Hassan Makki, Dearborn Heights, MI (US)

(73) Assignee: Ford Global Technologies, LLC, Dearborn, MI (US)

(21) Appl. No.: 15/439,484

(22) Filed: Feb. 22, 2017

(51) Int. Cl. B60W 30/165; G05D 1/00; G05D 1/12; G05D 1/02; G08G 1/0968; G07B 13/00

(52) U.S. Cl. CPC B60W 30/165; G05D 1/0088; G07B 13/00; G05D 1/0276; G08G 1/0968; G05D 1/12

(57) ABSTRACT

A computer that includes a processor and memory that stores instructions executable by the processor, so that the computer is programmed to: instruct a host vehicle to follow a leader vehicle; monitor driving behavior of the leader vehicle; and instruct the host vehicle to cease following the leader vehicle based on an abnormal driving action of the leader vehicle.

### BACKGROUND

Driving a motor vehicle in a fully autonomous mode can require substantial computing power onboard the vehicle. For example, fully autonomous vehicles may have a number of interconnected computers requiring substantial memory and relatively high processing speeds. In order to operate in a fully autonomous mode, these computers may be configured to determine and execute path and trajectory planning—e.g., using localization data, as well as inputs from a number of real-time vehicle sensors in order to avoid collisions with stationary objects, pedestrians, and other vehicles on the roadway. The resulting computational burden is relatively high when compared with the computational burden of non-autonomous vehicles or vehicles which operate only in a partially autonomous mode.

### SUMMARY

According to a first example, a computer is described that may be programmed to: instruct a host vehicle to follow a leader vehicle; monitor driving behavior of the leader vehicle; and instruct the host vehicle to cease following the leader vehicle based on an abnormal driving action of the leader vehicle.

According to another example, the computer further may be programmed to, prior to executing the instruction to follow the leader vehicle: transmit a follow request to a plurality of target vehicles; and select the leader vehicle from among the plurality of target vehicles based on a response to the follow request.

According to another example, the response includes one or more criteria that include: predetermined route data of the leader vehicle, proximity data of the leader vehicle, driver qualification data associated with the leader vehicle, or fare data associated with the leader vehicle, wherein the instruction to follow the leader vehicle is based on at least one of the one or more criteria.

According to another example, the computer further may be programmed to, prior to executing the instruction to follow the leader vehicle: transmit a follow request to a plurality of target vehicles; receive a plurality of responses from the respective plurality of target vehicles; and select the leader vehicle based on predetermined route data included within at least one of the plurality of responses.

According to another example, in response to detecting the abnormal driving action, the computer further may be programmed to transmit a follow request to a plurality of target vehicles, select a new leader vehicle based on a response to the follow request, and instruct the host vehicle to follow the new leader vehicle.

According to another example, monitoring the driving behavior further may comprise monitoring, at the host vehicle, whether the leader vehicle follows a predetermined route provided previously by the leader vehicle, wherein the abnormal driving action includes a routing deviation from the predetermined route.

According to another example, monitoring the driving behavior further may comprise monitoring, at the host vehicle, whether the leader vehicle follows a predetermined route provided previously by the leader vehicle, wherein the abnormal driving action includes a routing deviation from the predetermined route greater than a predetermined threshold.

According to another example, the computer further may be programmed to, after executing the instruction to cease following the leader vehicle, instruct the host vehicle, in an autonomous mode, to PARK.

According to another example, the computer further may be programmed to, after monitoring the driving behavior of the leader vehicle, provide a notification to a driver of the host vehicle to disable an autonomous towing mode at the host vehicle while the host vehicle is moving.

According to another example, the computer further may be programmed to determine that the host vehicle has reached a predetermined destination, and based on the determination, instruct the host vehicle to PARK.

According to another example, the computer further may be programmed to determine that the host vehicle is approaching a predetermined destination, and based on the determination, provide a notification to a driver of the host vehicle to disable an autonomous towing mode at the host vehicle.

According to a second example, a computer is described that may be programmed to: instruct a host vehicle to follow a first vehicle in an autonomous towing mode; broadcast a follow request while following the first vehicle; and based on receiving a response to the follow request from a second vehicle, instruct the host vehicle to follow the second vehicle in the autonomous towing mode.

According to another example, the computer further may be programmed to, prior to executing the instruction to follow the first vehicle: transmit an earlier follow request to a plurality of target vehicles; and select the first vehicle from among the plurality of target vehicles based on receiving a response to the earlier follow request.

According to another example, the computer further may be programmed to: store a host vehicle destination and store a first predetermined route provided to the host vehicle by the first vehicle, wherein the first predetermined route, when at least partially followed by the host vehicle, advances the host vehicle toward the destination.

According to another example, the computer further may be programmed to instruct the host vehicle to follow the second vehicle based on a second predetermined route provided to the host vehicle by the second vehicle, wherein the second predetermined route, when at least partially followed by the host vehicle: advances the host vehicle closer to the destination than continuing to follow the first predetermined route, advances the host vehicle more expeditiously toward the destination than by at least partially following the first predetermined route, or both.

According to another example, the computer further may be programmed to determine an abnormal driving action of the first vehicle, and in response to determining the abnormal driving action do at least one of the following: select a third vehicle and instruct the host vehicle to follow the third vehicle in the autonomous towing mode; instruct the host vehicle to PARK; or handover at least some vehicle control of the host vehicle to a user.

According to another example, the computer further may be programmed to determine an abnormal driving action of the first vehicle, wherein abnormal driving action includes a routing deviation from a predetermined route previously provided by the first vehicle that is greater than a predetermined threshold.

According to another example, the computer further may be programmed to determine that the host vehicle has reached a predetermined destination, and based on the determination, instruct the host vehicle to PARK.

According to another example, the computer further may be programmed to determine that the host vehicle is approaching a predetermined destination, and based on the determination, provide a notification to a driver of the host vehicle to disable an autonomous towing mode at the host vehicle.

According to another example, the response may include a plurality of criteria that include: predetermined route data of the second vehicle, proximity data of the second vehicle, driver qualification data associated with the second vehicle, and fare data associated with the second vehicle, wherein the instruction to follow the second vehicle is based on at least one of the plurality of criteria.

Any of the computer programming instructions described above and herein may be carried out as a method or process. Similarly, any methods or processes described above and herein may be carried out as instructions executable by a computing device such as a vehicle computer. Further, any of the examples described above may be used in any suitable combination with one another.

### BRIEF DESCRIPTION OF THE DRAWINGS

FIG. 1 is a schematic diagram that illustrates a host vehicle communicating with a plurality of target vehicles.

FIG. 2 is a schematic diagram showing an illustrative map and a predetermined destination of the host vehicle shown in FIG. 1.

FIG. 3 is a schematic diagram showing the illustrative map of FIG. 2, further illustrating the predetermined routes of several target vehicles.

FIG. 4 is a flow diagram illustrating a process of the host vehicle autonomously following at least one of the target vehicles.

### DETAILED DESCRIPTION

With reference to the figures, wherein like numerals indicate like parts throughout the several views, there is shown a host vehicle 10 that includes an autonomous towing system 12. During autonomous driving, the autonomous towing system 12 may minimize some of the computational demand required by operating the host vehicle 10 (which otherwise may operate in a fully autonomous mode) by effectively shifting the responsibility for computations pertaining to vehicle path planning, vehicle trajectory planning, etc. to a leader vehicle—which performs these computations (e.g., the leader vehicle being operated in a fully autonomous mode, or by a human driver). Thus in order for host vehicle 10 to reach a predetermined destination, vehicle 10 may be programmed to operate in an autonomous towing mode—thereby following the leader vehicle's actions (e.g., accelerating, slowing, stopping, turning, signaling, etc.) and/or reacting to vehicle-to-vehicle communications from the leader vehicle regarding its forthcoming actions.

Further, when the host vehicle 10 is autonomously towed by the leader vehicle, the leader vehicle may not need to go out of its way to deliver the host vehicle 10 to its desired destination. For example, the host vehicle 10 may repetitively monitor other potential leader vehicles on a roadway 13—e.g., searching for other potential leader vehicles which may assist the host vehicle 10 in getting to its destination more expeditiously (e.g., a more direct route) and/or which may assist the host vehicle 10 in getting closer to its destination (e.g., if the leader vehicle is not going to or past the destination). That is, host vehicle 10 may be programmed to switch and follow a second (or third, fourth, . . . ) leader vehicle to be autonomously towed the entire distance to its destination. As will be explained in greater detail below, towing system 12 of host vehicle 10 may include, among other things, at least one onboard computer 14 for making determinations associated with an autonomous towing process, a wireless communication module 16 for communicating with one or more potential leader vehicles 18, 20, 22, a human-machine interface (HMI) module 24 for receiving user input and/or providing towing-related output to a vehicle user (not shown), and a navigation system 26 to support computer 14 by providing navigation-related data.

Host vehicle 10 (as well as vehicles 18-22) may be passenger cars or any other suitable vehicles. For example, this includes any suitable trucks, sports utility vehicles (SUV), recreational vehicles, marine vessels, aircraft, track- and/or wheeled-military and/or heavy-equipment vehicles, or the like that includes onboard computer 14. Vehicle 10 may be operated in one or more autonomous modes, such as the autonomous towing mode discussed above. For example, the Society of Automotive Engineers (SAE) has defined autonomous mode operation as a number of different levels (e.g., levels 0-5), wherein at levels 0-2, a human driver monitors or controls the majority of the driving tasks, often with no help from the vehicle 10. For example, at level 0 (“no automation”), a human driver is responsible for all vehicle operations. At level 1 (“driver assistance”), the vehicle 10 sometimes assists with steering, acceleration, or braking, but the driver is still responsible for the vast majority of the vehicle control. At level 2 (“partial automation”), the vehicle 10 can control steering, acceleration, and braking under certain circumstances without human interaction. At levels 3-5, the vehicle 10 assumes more driving-related tasks. At level 3 (“conditional automation”), the vehicle 10 can handle steering, acceleration, and braking under certain circumstances, as well as monitoring of the driving environment. Level 3 may require the driver to intervene occasionally, however. At level 4 (“high automation”), the vehicle 10 can handle the same tasks as at level 3 but without relying on the driver to intervene in certain driving modes. At level 5 (“full automation”), the vehicle 10 can handle all tasks without any driver intervention.

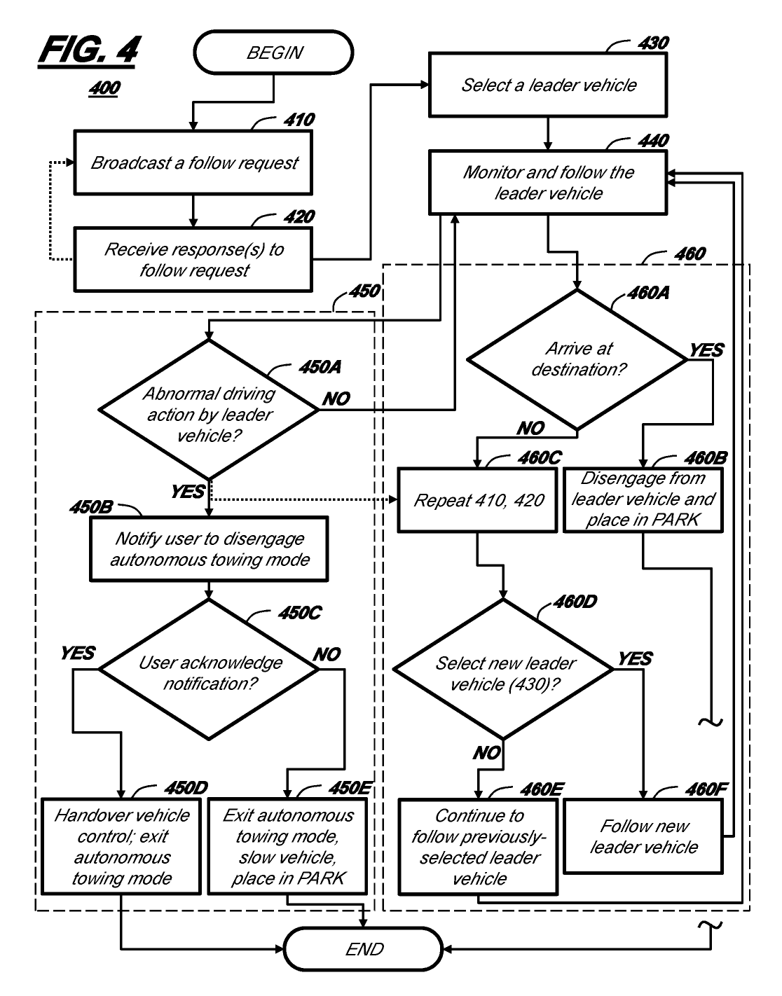

In at least one example, alternatively or in addition to the levels described above, host vehicle 10 may operate in an autonomous towing mode which may be a hybrid of levels 4 and 5. Prior to entering this mode, the user may create or input autonomous towing mode settings—e.g., configuring user-adjustable parameters (described in greater detail below). Then, the user may selectively enter the autonomous towing mode—e.g., by making a selection via HMI module 24. Further, once the autonomous towing mode is selected—from the perspective of the user—the host vehicle 10 may appear to operate in the fully autonomous mode while the vehicle 10 moves toward its destination (e.g., appear to imitate level 5 autonomy; e.g., no user interaction being required). However, on a computational level, host vehicle 10 may execute one or more different algorithms, routines, sensor-data collection and analyses, etc. than typically required when operating in the fully autonomous mode. More particularly, at a computational level, operating the host vehicle 10 in the autonomous towing mode may require less memory and less processing capability—or alternatively, utilize less existing temporary memory and reserve existing processing power for other vehicle operations. This autonomous towing mode will be described in greater detail below (see process 400, FIG. 4).

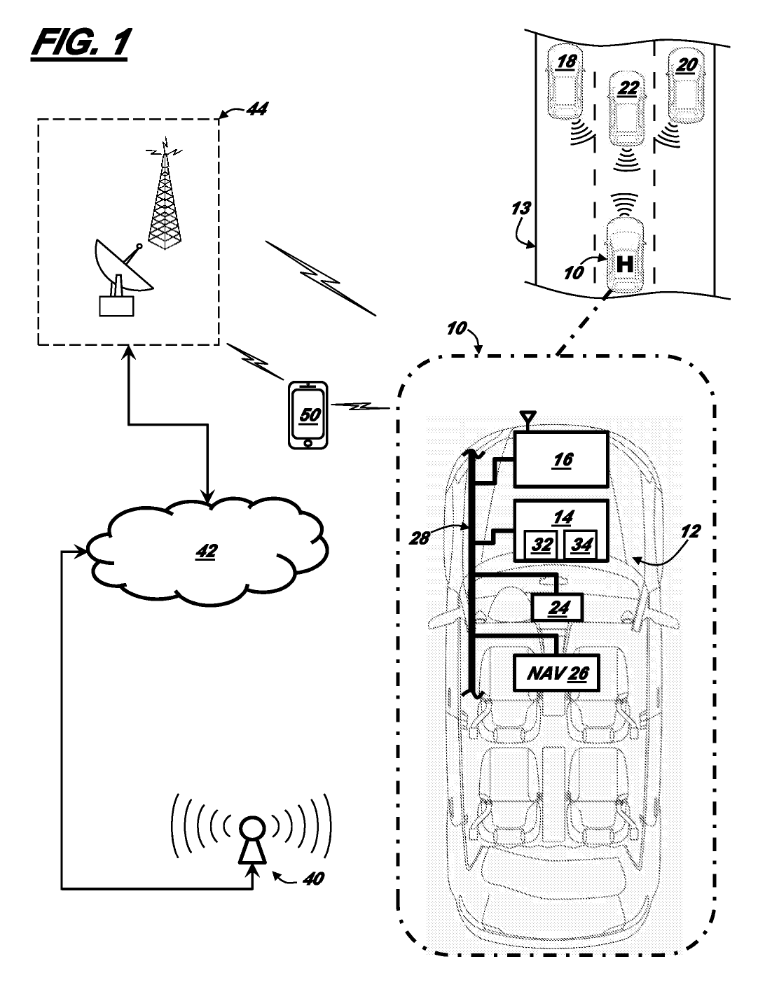

As shown in FIG. 1, host vehicle 10 may include any suitable wired or wireless network connection 28 enabling communication between electronic devices such as computer 14, wireless communication module 16, HMI module 24, navigation system 26, and the like. In at least one example, the network connection 28 includes one or more of a controller area network (CAN) bus, Ethernet, Local Interconnect Network (LIN), or the like. Other examples also exist. For example, alternatively or in combination with e.g., a CAN bus, network connection 28 could comprise one or more discrete wired or wireless connections.

Computer 14 may be a single computer (or multiple computing devices—e.g., shared with other vehicle systems and/or subsystems). In at least one example, computer 14 is an autonomous towing control module; however, this is merely an example. Computer 14 may comprise a processor or processing circuit 32 coupled to memory 34. For example, processor 32 can be any type of device capable of processing electronic instructions, non-limiting examples including a microprocessor, a microcontroller or controller, an application specific integrated circuit (ASIC), etc.—just to name a few. In general, computer 14 may be programmed to execute digitally-stored instructions, which may be stored in memory 34, which enable the computer 14, among other things, to: receive predetermined destination data from the host vehicle user (e.g., via HMI module 24); instruct the wireless communication module 16 to broadcast a follow request to potential leader vehicles 18-20 (e.g., hereafter, referred to as target vehicles 18-20); receive a response from one or more target vehicles 18-20; select a leader vehicle from among the target vehicle(s) 18-22 based on one or more criteria within the received response(s); instruct the host vehicle 10 to follow the leader vehicle (e.g., leader vehicle 18); broadcast an additional follow request while following the leader vehicle 18; receive one or more responses (e.g., possibly from different target vehicles); based on criteria in the received responses, select and follow a new leader vehicle (e.g., from among these target vehicles); and when the host vehicle 10 arrives at the user's predetermined destination, instruct the host vehicle 10 to discontinue following the current leader vehicle.

Memory 34 may include any non-transitory computer usable or readable medium, which may include one or more storage devices or articles. Exemplary non-transitory computer usable storage devices include conventional computer system RAM (random access memory), ROM (read only memory), EPROM (erasable, programmable ROM), EEPROM (electrically erasable, programmable ROM), as well as any other volatile or non-volatile media. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read. As discussed above, memory 34 may store one or more computer program products which may be embodied as software, firmware, or the like—including but not limited to an autonomous towing mode computer program product.

Wireless communication module 16 may be any suitable telematics device configured to wirelessly communicate with other electronic devices—namely, wirelessly communicate with other vehicles (e.g., such as target vehicles 18-22). Such wireless communication—e.g., commonly referred to as vehicle-to-vehicle (V2V) communication—may include use of cellular technology, short range wireless communication technology, or a combination thereof. Thus, for example, module 16 could utilize a Bluetooth Low Energy (BLE) protocol which enables Just Works™ or other suitable pairing techniques to order to communicate with target vehicles 18-22. In general, module 16 may act as a gateway device—e.g., converting a BLE communication into suitable serial data to be transmitted over network connection 28 to computer 14, or vice-versa. Thus using network connection 28, as will be explained below, module 16 may receive from computer 14 a follow request message instruction, transmit or broadcast a follow request message via any suitable protocol in response to the instruction, then receive one or more associated response messages from target vehicles 18-22, and subsequently provide the response messages to computer 14 for evaluation.

As will be described in greater detail below, such V2V communication may be used by computer 14 to select a leader vehicle to follow in the autonomous towing mode, as well as to maintain communication with the leader vehicle during autonomous towing. For example, using V2V, the leader vehicle may indicate to the host vehicle 10 that it intends to turn left or right at a designated street ahead, that it is merging into another roadway lane ahead, that the leader vehicle intends to pass through a yellow traffic light ahead, that the leader vehicle is diverging from its originally intended route, and why the leader vehicle is diverging from its originally intended route (e.g., an accident, heavy traffic, the leader vehicle has changed its intended destination, etc.), just to name a few non-limiting examples.

Human-machine interface (HMI) module 24 may include any suitable input and/or output devices such as switches, knobs, controls, etc.—e.g., on an instrument panel, steering wheel, etc. of host vehicle 10—which are coupled communicatively to computer 14. In one non-limiting example, HMI module 24 may comprise an interactive touch screen or display which provides navigation information (e.g., including text, images, etc.) to the vehicle user, permits the user to enter or adjust parameters associated with the autonomous towing mode, enables the user to select a desired destination, and as will be explained in greater detail below, enables the user to disengage or exit an autonomous towing mode associated with a particular leader vehicle.

Navigation system 26 includes any suitable electronic device used to determine position data and/or heading data of the host vehicle 10. Non-limiting examples of system 26 include a Global Positioning System (GPS) unit and a Global Navigation Satellite System (GLONASS) device. As described below, navigation system data may be received by computer 14 and may be used to: predetermine a route to a user-requested destination; determine which of a plurality of target vehicle routes are best suited for host vehicle 10 to follow; and identify when the host vehicle 10 is at or approaching its desired destination.

Thus, host vehicle 10 may include a number of additional mechanical and/or electrical systems, control systems, etc. (not shown herein or described in detail herein) that facilitate operation in an autonomous mode, all of which are known in the art. Non-limiting examples of such systems include a powertrain system providing forward and/or rearward propulsion to the wheels of vehicle 10, a steering system providing right, left turning capability, braking systems to slow or stop host vehicle 10, object detection systems used to locate and identify other objects in the roadway 13 relative to host vehicle 10 (e.g., including other vehicles, roadway obstacles, etc.), digital imaging systems enabling lane monitoring, object tracking, object following (e.g., following a leader vehicle), etc. This list is not intended to be limiting, but is provided for illustrative purposes only. These and other systems each may receive any suitable sensor data and utilize this data in one or more software algorithms to carry out the designated functions thereof. In one non-limiting example, host vehicle 10 receives LIDAR data, radar data, and/or camera data from onboard sensors and executes an autonomous towing mode algorithm that tracks and follows a leader vehicle (e.g., within a line-of-sight (LOS))—e.g., following behind the leader vehicle at a safe distance. Such leader-follower algorithms are known and will not be described in greater detail here.

FIG. 1 also illustrates a number of other communication components—e.g., a short range wireless transceiver 40 which may be coupled to any suitable roadway or roadside infrastructure (e.g., to facilitate so-called vehicle-to-infrastructure (V2I) communication). Transceiver 40 may be coupled to a land communication network 42 which also may be coupled to a wireless communication network 44. The land communication network 42 can enable connectivity to public switched telephone network (PSTN) such as that used to provide hardwired telephony, packet-switched data communications, internet infrastructure, and the like. Wireless communication network 44 may include satellite communication architecture and/or may include cellular telephone communication over wide geographic region(s). Thus, in at least one example, network 44 includes any suitable cellular infrastructure that could include eNodeBs, serving gateways, base station transceivers, and the like. Further, network 44 may utilize any suitable existing or future cellular technology (e.g., including LTE, CDMA, GSM, etc.). V2I 40, land communication network 42, and wireless communication network 44 are generally known in the art and will not be described further herein. It should be appreciated that V2V communication may utilize V2I 40 as well—e.g., wherein V2I 40 serves as a wireless access point (WAP) or hub and the vehicles 10, 18-22 are spokes, in a so-called hub-and-spoke network.

In at least some examples, a mobile device 50 may be used with host vehicle 10 as well—e.g., to request an autonomous taxi (e.g., to hail a leader vehicle, as in hailing a taxicab), to provide an indication to computer 14 of the user's desired destination (e.g., prior to entering vehicle 10), or the like. Thus, in at least one example, device 50 may communicate with vehicle 10 (and computer 14) via wireless communication module 16. Non-limiting examples of mobile device 50 include a cellular telephone, a personal digital assistant (PDA), a Smart phone, a laptop or tablet computer having two-way communication capabilities (e.g., via a land and/or wireless connection), a netbook computer, and the like.

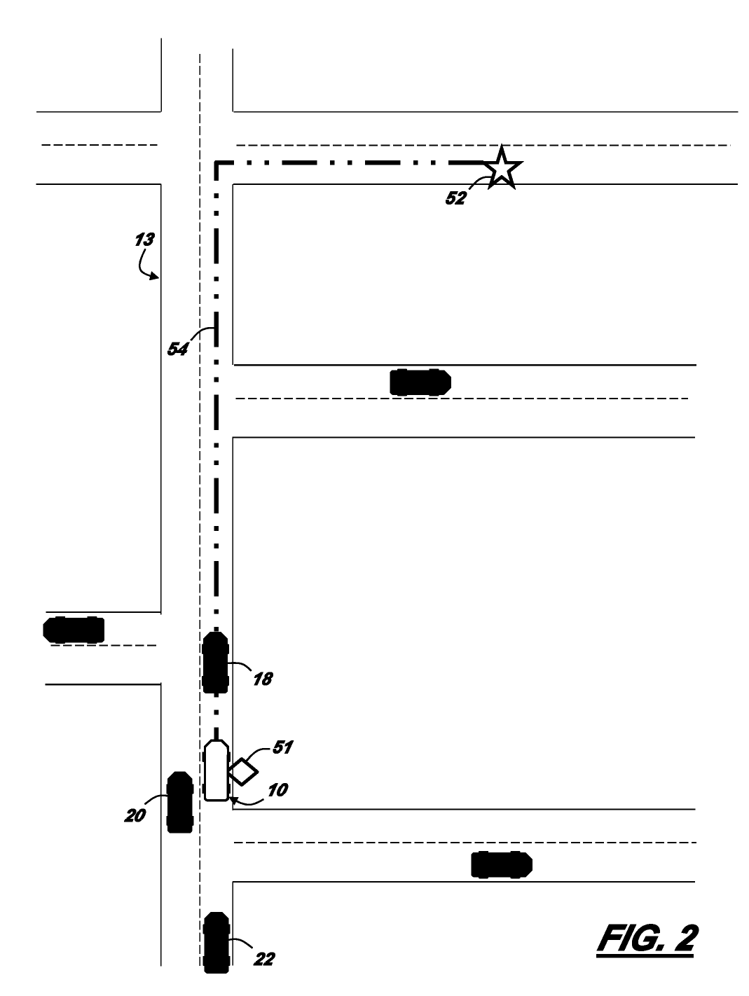

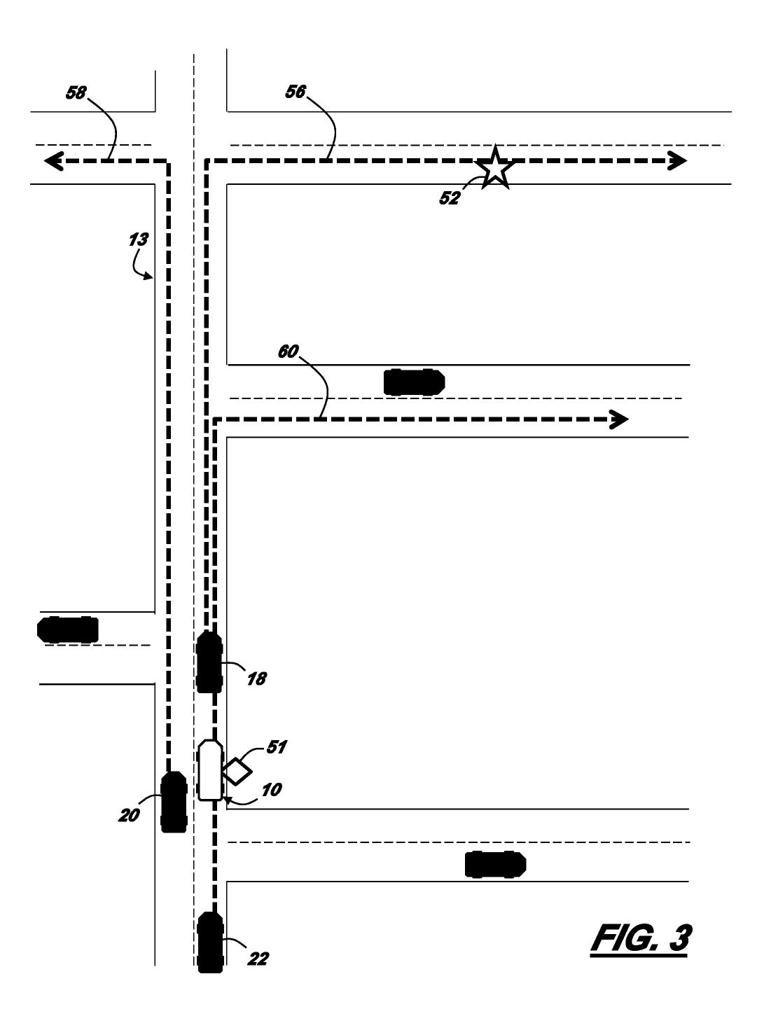

Turning now to FIGS. 2-3, host vehicle 10 and target vehicles 18-22 are shown on traveling on roadway 13. More particularly, FIG. 2 illustrates a current location 51 of host vehicle 10 (e.g., position data being received by computer 14 via navigation system 26) and a predetermined destination location 52 of the vehicle user (e.g., received at computer 14 via HMI module 24, mobile device 50, etc.). Locations 51, 52 may be stored in memory 34. A proposed route 54 between locations 51, 52 is also shown, which may be generated by the navigation system 26 based on the user's destination input data and which then may be provided to and stored in memory 34 as well. In many instances, this route 54 may be the most direct path which may be traveled by the host vehicle 10 to reach destination 52 (e.g., a route requiring the least mileage). However, other examples exist. For instance, the route 54 may not always be the shortest distance; instead, proposed route 54 may be determined by navigation system 26 to be the fastest (e.g., the most expeditious path between locations 51, 52). As will be appreciated by skilled artisans, more expeditiousness of a route may be based on a number of factors: total mileage, permissible speed limits along a proposed route 54, traffic volume, the presence of vehicle accidents along a route, temporarily closed roadways, etc. In some instances, navigation system 26 may determine more than one route—e.g., multiple routes of equal distance, multiple routes of equal expeditiousness, etc.

FIG. 3 illustrates the same exemplary roadway 13 and the same vehicles 10, 18-22 in the same locations as shown in FIG. 2. However, FIG. 3 shows predetermined routes 56, 58, 60 of target vehicles 18-22 (e.g., vehicles 18-22 may have previously determined a route to follow or a route to a respective destination of their own). Routes 56-60 may be based on navigation data entered into a computer onboard each of these vehicles 18-22 (e.g., similar to the navigation system 26 described above), or the routes 56-60 could be predetermined by computers onboard the respective vehicles 18-22, or the routes 56-60 could be preconfigured routes (e.g., like a bus route). These are merely examples; other route types also may be used. Regardless of the type, the respective target vehicles 18-22 may have some form of predetermined routes. As will be explained below, when the host vehicle 10 makes a follow request, each of these vehicles 18-22 may respond with predetermined route data, among other things. In FIG. 3, the vehicles shown which do not respond to the follow request may not have predetermined route data, may not desire to respond to the host vehicle's follow request, etc.—e.g., not all proximately-located vehicles may be potential leader vehicles of host vehicle 10.

Turning now to FIG. 4, a process 400 of the host vehicle 10 using an autonomous towing mode to follow at least one of the target vehicles 18-22 is shown. In block 410, the host vehicle 10 broadcasts a follow request—e.g., the computer 14 instructs the wireless communication module 16 to transmit a wireless message (e.g., via Wi-Fi, Bluetooth, BLE, etc.) indicating that the host vehicle 10 desires to enter the autonomous towing mode by having another vehicle lead it (at least partially) to predetermined destination 52 (see also FIGS. 2-3). As described above, the follow request may be initiated by a vehicle user of host vehicle 10; e.g., the user may provide destination data via the HMI module 24, the mobile device 50, or the like. And in turn, computer 14 may instruct the wireless communication module 16 to broadcast the follow request to one or more potential leader vehicles according to any suitable wireless protocol.

In response to the follow request, host vehicle 10 may receive one or more responses from potential vehicles within a reception range of the wireless transmission (block 420). If no response is received, then process 400 may loop back and repeat block 410. For purposes of illustration only and not to be limiting, in block 420, a response may be received from each of target vehicles 18-22. Each of these responses may include one or more autonomous towing criteria including, but not limited to: predetermined route data, proximity data, driver qualification data, and/or fare data. In at least one example, only predetermined route data is provided in the responses; however, in other examples, predetermined route data and one or more additional criteria are provided in at least one of the responses.

As used herein, predetermined route data is data pertaining to a path upon which the respective target vehicle intends to travel (e.g., to reach its desired destination). For example, the predetermined route data may include segments of streets, highways, etc. upon which the respective target vehicle intends to travel, distances to travel along each of the segments, right and/or left turns to different segments, etc. The predetermined route data also could include multiple waypoints defining a path of travel or any other suitable means of navigation to the respective target vehicle's destination. The predetermined route data provided to host vehicle 10 does not need to comprise the entirety of the respective target vehicle's trip—e.g., instead, it may include only route data that subsumes at least a suitable portion of a path between location 51 and destination location 52.

As used herein, proximity data is an indication of a relative closeness of the respective target vehicle to host vehicle 10. For example, proximity data may include heading data (e.g., direction and/or speed/velocity) and position data (e.g., latitudinal and longitudinal coordinates) of the respective target vehicle—enabling the computer 14 to determine the relative closeness of the respective target vehicle. Using the proximity data, closeness may be determined by computer 14 according to distance, time, or a combination thereof. In at least one example, received proximity data is used to determine relative closeness in time—e.g., a duration of time until the respective target vehicle reaches the host vehicle 10 from the respective target vehicle's current position—e.g., representing the soonest time in which autonomous towing of vehicle 10 could begin.

As used herein, driver qualification data is any information associated with a driver of a respective target vehicle. This information may include traffic violation history associated with a human driver, number of accidents associated with the respective target vehicle, number of accidents associated with the respective human driver, duration of autonomous towing experience (e.g., number of hours, months, years, etc.), etc.—these are merely examples; other examples exist. Thus, the driver may be one or more computers and/or a human. In at least one example, the driver qualification data includes a rating of driving style—e.g., aggressive, neutral, passive, etc.—e.g., which may be used in a target vehicle selection process (block 430, described below).

As used herein, fare data is any information associated with a monetary charge issued to the user of the host vehicle 10 from a leader vehicle for performing an autonomous towing service. Thus, the fare data may include estimated charges for autonomously towing the host vehicle 10 to or toward its predetermined destination 52. As explained below, the fare data may or may not pertain to charges for towing the vehicle 10 the entire distance between locations 51, 52.

In block 430 which follows, computer 14 in host vehicle 10 may select a leader vehicle from among the plurality of target vehicles which respond to the follow request (e.g., continuing with the example above, selecting a leader vehicle from among target vehicles 18-22). The selection may be based on one or more autonomous towing criteria received in the response(s) at block 420. In at least one example, the computer 14 evaluates the predetermined route data provided by each of vehicles 18-22 and compares the predetermined routes 56-60 of each of the target vehicles 18-22 to a proposed route (e.g., 54). In this simplified example, each of vehicles 18-22 are near to (or will pass by) host vehicle 10 and, if followed by host vehicle 10, will advance the host vehicle closer to its destination 52. For example, route 58 could advance the host vehicle 10 approximately 66% of the distance from location 51 to location 52, and route 60 could advance the host vehicle 10 approximately 33% of the distance from location 51 to location 52; however, if host vehicle 10 follows one of target vehicles 20, 22, neither—without deviating from their intended paths—will autonomously tow vehicle 10 all the way to its destination 52. Thus, in at least one example, host vehicle 10 may select target vehicle 18 to tow or lead it (thus, now designated leader vehicle 18) because its route 56 can advance host vehicle 10 the entirety of the distance from location 51 to location 52. Thus, as used herein, a leader vehicle is a potential target vehicle which responds to a follow request from the host vehicle 10 and which is selected by computer 14 to be followed for at least a portion of its trip between two locations (e.g., 51, 52).

In block 430 (as part of the leader vehicle selection process), computer 14 may evaluate other autonomous towing criteria as well—instead of or in addition to whether the predetermined route data provided by the respective target vehicles includes both locations 51, 52. For example, computer 14 may consider the distance traveled between locations 51, 52—e.g., while not shown in FIGS. 2-3, two different target vehicles both could pass by locations 51, 52; however, one could travel more directly from location 51 to location 52, whereas the other could take a lengthier route.

Another criterion considered by the computer 14 may be autonomous towing mode travel time between locations 51, 52. Continuing with the example of two different target vehicles each traveling between locations 51, 52, computer 14 may select the target vehicle which is likely to arrive first at destination 52. For example, computer 14 may use navigation system 26 and/or other suitable data to calculate expected travel times of the two respective target vehicles. This determination may or may not include a traffic volume calculation, evaluation of accident information along one or both proposed routes, etc. Thus, in at least some circumstances, the shortest distance between locations 51, 52 may not be the fastest—and computer 14 may be programmed to select the target vehicle providing the most expeditious route.

Another criterion considered by computer 14 in block 430 may be proximity data transmitted within the responses of target vehicles 18-22. For example, alternatively or in addition to the determinations made above, computer 14 may determine how long it will take each of vehicles 18-22 to reach its location 51—e.g., so that it may begin to be autonomously towed. Consequently, computer 14 may be programmed to select the target vehicle which may arrive the soonest to location 51.

Another criterion considered by computer 14 in block 430 may be driver qualification data. For example, the vehicle user of host vehicle 10 may have previously configured autonomous towing mode settings using HMI module 24 (or mobile device 50); and these settings may be stored in computer memory 34. For example, the settings may enable the user to adjust parameters associated with leader vehicle selection that include threshold traffic violation history (of a driver of a potential leader vehicle), threshold number of accidents associated with the respective target vehicle, threshold number of accidents associated with the respective human driver, threshold duration of autonomous towing experience of the respective human driver, a threshold driving style of the respective human driver, etc. To illustrate—and not to be limiting—parameters stored in memory 34 could include ‘0 traffic violations in the past 3 years,’ ‘0 accidents associated with any target vehicle,’ ‘0 accidents associated with any target vehicle human driver,’ ‘minimum 1000 hours of autonomous vehicle towing experience,’ and ‘a passive driving style.’

And yet another exemplary criterion considered by computer 14 in block 430 may be fare data. For example, user of host vehicle 10 also could previously configure a fare parameter in the autonomous towing mode settings. Thus, computer 14 may compare fare data received from a potential leader vehicle with the stored parameter. Non-limiting examples of the fare parameter includes a maximum fare per mile, a maximum fare for preconfigured trips (e.g., from location 51 to location 52 which could be, e.g., from an airport to a local hotel or the like), etc. Thus, computer 14 may not select potential leader vehicles having fare data larger (or even smaller) than a threshold.

In at least one example, computer 14 selects a leader vehicle (e.g., target vehicle 18) based on any suitable combination of these criteria—further, the computer 14 may weigh some criteria heavier than others. Weight given to target vehicle route parameters, target vehicle proximity parameters, driver qualification parameters of the respective target vehicles, fare parameters of the respective target vehicles, etc. may or may not be previously configured by the vehicle user in the autonomous towing mode settings. In at least one non-limiting example, a plurality of criteria from target vehicles 18-22 may be considered to determine the most expeditious trip between locations 51, 52.

Once the leader vehicle 18 is selected, process 400 may continue with block 440. In block 440, computer 14 may instruct the host vehicle 10 to enter the autonomous towing mode and follow the selected leader vehicle 18. Further, in block 440, computer 14 begins to monitor driving behavior of the leader vehicle 18—e.g., as it follows it. Monitoring leader vehicle 18 includes any sensory monitoring—e.g., using LIDAR, radar, and/or camera monitoring techniques, etc. For example, as discussed below, computer 14 may monitor for any abnormal driving action of vehicle 18. It also may include monitoring V2V communications from leader vehicle 18 to host vehicle 10—e.g., including but not limited to communications from leader vehicle 18 that it is changing its route 56, updating its destination, etc.

Following block 440, process 400 next may execute instructions associated with blocks 450 and/or 460—each of which may include a number of sub-blocks. As will be apparent from the discussion below, blocks 450, 460 may occur at least partially concurrently. Each will be discussed in turn.

With respect to sub-block 450A of block 450, computer 14 may determine whether an abnormal driving action has occurred at leader vehicle 18. If an abnormal driving action has occurred, the process 400 may proceed to sub-block 450B, and if no abnormal driving action has occurred, then process 400 may loop back to block 440 and continue to monitor the driving behavior of leader vehicle 18. The loop of blocks 440 and 450A may occur repetitively. As used herein, an abnormal driving action includes any driving action during autonomous towing that is determined by computer 14 to jeopardize the safety of the vehicle user or host vehicle 10 and/or any driving action determined by computer 14 to be an indication that the leader vehicle 18 is deviating more than a threshold from its predetermined route (e.g., which was previously provided in its response, block 420). Non-limiting examples of driving actions which may jeopardize the safety of the vehicle user or host vehicle 10 include: leader vehicle 18 exceeding the maximum posted speed limit on roadway 13; leader vehicle 18 exceeding a maximum speed configured by the vehicle user (e.g., in the autonomous towing mode settings); leader vehicle 18 changing lanes on roadway 13 excessively (e.g., changing lanes more than a threshold quantity of times within a predetermined distance of roadway 13); leader vehicle 18 exhibiting behavior indicative of a undesired driving style (e.g., driver qualification data indicated leader vehicle driving style was ‘passive,’ however, driving actions indicate that driving style is presently ‘aggressive’); leader vehicle 18 fails to stop at a red traffic light; leader vehicle 18 fails to stop at a yellow traffic light and the host vehicle 10 cannot safely proceed therethrough; the leader vehicle 18 weaves within a roadway lane (e.g., suggesting that a human driver of the leader vehicle is drowsy, intoxicated, etc.).

Non-limiting examples of driving actions which may indicate that the leader vehicle 18 is deviating more than a threshold from its predetermined route (i.e., a routing deviation) include: any deviation from the predetermined route data provided in the response of block 420—e.g., the threshold permitting zero route deviation; any deviation from the predetermined route data provided in the response of block 420 greater than a computer-determined threshold or a user-defined threshold (e.g., previously configured in autonomous towing mode settings); any deviation from a predetermined route of leader vehicle 18 that is not communicated by the leader vehicle to host vehicle 10 (e.g., via V2V communication) prior to leader vehicle 18 making the deviation (e.g., which may or may not require host vehicle acknowledgement/acceptance); and/or any V2V communication that leader vehicle 18 has changed its destination and will no longer be following the predetermined route data provided in block 420. The computer-determined or user-defined thresholds may be based on added travel distance, added travel time, or the like. Thus, the threshold may be 1 extra mile of travel, or 5 extra minutes of travel, etc.; consequently, any deviation greater than this amount can trigger computer 14 to identify an abnormal driving action. In at least one example, computer 14 may observe a route deviation by leader vehicle 18, determine (using data from navigation system 26) that the cause of the route deviation is due to a temporary roadway delay (e.g., closed roadway, vehicular accident involving other vehicles, heavy traffic volume, etc.), and correspondingly determine that the deviation is not an abnormal driving action; consequently, computer 14 could loop back and repeat block 440 (rather than proceeding to sub-block 450B).

In at least one example, abnormal driving actions may be categorized into soft abnormal driving actions or hard abnormal driving actions. For example, soft abnormal driving actions, when determined by computer 14, may permit the user of host vehicle 10 to selectively disengage the autonomous towing mode (e.g., based on preference) and/or may require computer 14 to determine multiple undesirable soft abnormal driving actions by leader vehicle 18 before computer 14 is configured to disengage leader vehicle 18. However, for example, when computer 14 determines a hard abnormal driving action, computer 14 may be configured to immediately disengage the autonomous towing mode (e.g., handing over control of vehicle 10 to the user, operating the vehicle 10 in a fully autonomous mode, and/or safely slowing vehicle 10 to a stop and placing a transmission of vehicle 10 in PARK)—e.g., proceeding directly to sub-block 450D or 450E (discussed below). Examples of soft and hard actions are plentiful, and an exhaustive list will not be provided herein; however, to illustrate, a soft abnormal driving action may be changing lanes too frequently, and a hard abnormal driving action may be the leader vehicle running a red traffic light, both non-limiting examples being described above.

In sub-block 450B (which may follow sub-block 450A), computer 14 may notify the vehicle user of host vehicle 10 to disengage the autonomous towing mode (e.g., while the vehicle 10 is moving—e.g., by displaying a notification via HMI module 24). This notification may include a visual alert, an audible alert, a tactile alert, or any combination thereof.

In sub-block 450C (which follows sub-block 450B), computer 14 may determine whether the vehicle user acknowledges the notification. For example, the vehicle user may acknowledge by providing one or more inputs via HMI module 24. When the user acknowledges, process 400 may proceed to sub-block 450D, and when the user does not acknowledge the notification (e.g., the user is distracted, asleep, etc.), then the process may proceed to sub-block 450E.

In sub-block 450D, the computer 14 may perform a handover procedure to handover vehicle control to the vehicle user of host vehicle 10. For example, once computer 14 verifies that the user has control (e.g., in any suitable manner), the computer 14 may exit the autonomous towing mode. Thereafter, the process may end.

In sub-block 450E, the computer 14 may be programmed to enter a fully autonomous mode and/or safely stop vehicle 10—e.g., and thereafter place the transmission of vehicle 10 in PARK in a safe location. Thereafter, the process may end. Of course, following either of sub-block 450D or 450E, computer 14 alternatively could loop back and repeat blocks 410, 420 to enable host vehicle 10 to reach its destination 52.

Returning to block 460 (which also may follow block 440, as described above), computer 14 may determine whether host vehicle 10 has arrived at its destination location 52 (sub-block 460A). In at least one example, the host vehicle computer 14 may evaluate its present location information (e.g., using data from the navigation system 26) and compare its location information with the predetermined destination 52. If in sub-block 460A computer 14 determines that its present location information matches destination location 52 (or is within a threshold distance (e.g., such as 500 feet)), then it may determine that host vehicle 10 has arrived, and process 400 may proceed sub-block 460B. However, if present location information does not match destination location 52, then process 400 may proceed to sub-block 460C.

In sub-block 460B (having arrived at the destination 52), computer 14 may instruct the host vehicle 10 to disengage the autonomous towing mode and consequently cease following leader vehicle 18. For example, after disengagement, vehicle 10 may operate in a fully autonomous mode to safely stop vehicle 10 in a safe location, and place the transmission in PARK (e.g., similar to that discussed above with respect to sub-block 450E). Of course, alternatively, computer 14 could notify the vehicle user and instruct systems within host vehicle 10 to execute the handover procedure discussed above (e.g., in sub-blocks 450C, 450D, etc.). Thereafter, after autonomously towing host vehicle 10 to destination location 52, process 400 may end.

It should be appreciated that sub-block 460A similarly could determine whether the host vehicle 10 is approaching the destination 52. Then, e.g., based on the determination (in sub-block 460B), computer 14 could provide a notification to the user of host vehicle 10 to disable the autonomous towing mode—thereby giving the user some notice before the vehicle 10 arrives at destination 52. Thereafter, the user could take over control via the handover procedure, etc.

In sub-block 460C (wherein computer 14 determines that host vehicle 10 has not arrived at the destination 52), computer 14 may repeat the subject matter of blocks 410 and 420 to consider whether other potential leader vehicles are available. This may be desirable for one or more reasons. For example, based on the predetermine route data previously provided by leader vehicle 18, host vehicle 10 may know that leader vehicle 18 may not be autonomously towing vehicle 10 the entirety of the distance between locations 51 and 52. Or for example, computer 14 may determine that by switching leader vehicles, host vehicle 10 may arrive sooner at destination 52, that host vehicle 10 will be charged less total fare, etc. FIG. 4 also illustrates that process 400 could proceed from sub-block 450A to sub-block 460C—e.g., illustrating that switching leader vehicles may be based on the abnormal driving actions of leader vehicle 18. In at least one example, process 400 proceeds from sub-block 450A to sub-block 460C based on a soft abnormal driving action; however, this is not required (e.g., it could proceed to sub-block 460C based on a hard abnormal driving action as well).

In sub-block 460D which follows sub-block 460C, computer 14 may determine whether to follow a new leader vehicle. In at least one example, the evaluation performed by computer 14 in sub-block 460D may be identical to block 430 described above; therefore, it will not be re-described in detail here. In sub-block 460D, computer 14 also may calculate a remaining distance (to location 52) and/or traveling time with respect to host vehicle 10 continuing to follow leader vehicle 18; of course, other criteria also could be evaluated, as discussed above. Computer 14 may compare these calculations with predetermined route data and/or other criteria provided within the response(s) of the potential new leader vehicles.

In sub-block 460E, computer 14 determines to continue to follow the current or most previously-selected leader vehicle (e.g., vehicle 18); thereafter, process 400 loops back to block 440 and repeats blocks 450 and/or 460. In sub-block 460F, computer 14 determines to continue to follow a new leader vehicle; thus, computer 14 disengages the autonomous towing mode with respect to leader vehicle 18 and re-engages the autonomous towing mode with respect to the newly selected leader vehicle. Thereafter, process 400 loops back to block 440 and repeats blocks 450 and/or 460—except with respect to the new leader vehicle.

It should be appreciated that while not shown in FIG. 4, the vehicle user manually may disengage the autonomous towing mode at any suitable time. For example, the user may change his or her desired destination (e.g., no longer desiring to travel to location 52), or the user may detect abnormal driving actions or other non-preferential driving behavior by the leader vehicle 18 and provide an input to HMI module 24 to disengage the autonomous towing mode. Such inputs are provided to computer 14, and computer 14 instructs host vehicle 10 to disengage. Thereafter, the user may assume control of host vehicle 10, host vehicle 10 may enter a fully autonomous mode, or the computer 14 may facilitate a combination thereof.

Other autonomous towing mode implementations also exist—e.g., not shown or described with respect to process 400. For example, as described above, host vehicle 10 can use LIDAR data, radar data, and camera data in the autonomous towing mode to track and follow leader vehicle 18. These sensors may be provided in vehicle 10 because operation in a fully autonomous mode may require redundant data; however, in at least one non-limiting example, operation in the autonomous towing mode does not required the same redundancies as is required by a fully autonomous mode. For example, vehicle 10 may execute the autonomous towing mode by using only radar and vehicle-to-vehicle (V2V) communication (e.g., communication between host vehicle 10 and a respective leader vehicle). In this manner, the autonomous towing mode may be executed in environmental circumstances not conducive to receiving camera data—e.g., during low-visibility conditions (e.g., darkness, dense fog, heavy rain, smoky or dusty conditions, etc.). This makes the use of the autonomous towing mode suitable in the event of a sensor failure—e.g., if one or more of the host vehicle cameras failed and/or one or more LIDAR sensors failed, host vehicle 10 may not be suitable for operation in a fully autonomous mode; however, it still may be operable in the autonomous towing mode. Accordingly, this may enable host vehicle 10 to travel follow a leader vehicle to a vehicle service center for repair or the like.

Thus, there has been described an autonomous towing system for a host vehicle. The system includes a computer that can instruct the host vehicle to follow a leader vehicle in an autonomous towing mode. Further, the computer may determine to disengage the autonomous towing mode based upon various determinations made by the computer (e.g., including but not limited to an abnormal driving action at the leader vehicle).

In general, the computing systems and/or devices described may employ any of a number of computer operating systems, including, but by no means limited to, versions and/or varieties of the Ford SYNC® application, AppLink/Smart Device Link middleware, the Microsoft® Automotive operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

The processor is implemented via circuits, chips, or other electronic component and may include one or more microcontrollers, one or more field programmable gate arrays (FPGAs), one or more application specific circuits ASICs), one or more digital signal processors (DSPs), one or more customer integrated circuits, etc. The processor can receive the data from the sensors and determine, from the data, how to follow a leader vehicle. The processor may be programmed to process the sensor data. Processing the data may include processing the video feed or other data stream captured by the sensors to determine the roadway lane of the host vehicle and the presence of any target vehicles. As described below, the processor instructs vehicle components to actuate in accordance with the sensor data. The processor may be incorporated into a controller, e.g., an autonomous mode controller.

The memory (or data storage device) is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The memory may store data collected from sensors.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A computer, programmed to:
instruct a host vehicle to follow a leader vehicle;
monitor driving behavior of the leader vehicle; and
instruct the host vehicle to cease following the leader vehicle based on an abnormal driving action of the leader vehicle.

2. The computer of claim 1, wherein the computer further is programmed to, prior to executing the instruction to follow the leader vehicle: transmit a follow request to a plurality of target vehicles; and select the leader vehicle from among the plurality of target vehicles based on a response to the follow request.

3. The computer of claim 2, wherein the response includes one or more criteria that include: predetermined route data of the leader vehicle, proximity data of the leader vehicle, driver qualification data associated with the leader vehicle, or fare data associated with the leader vehicle, wherein the instruction to follow the leader vehicle is based on at least one of the one or more criteria.

4. The computer of claim 1, wherein the computer further is programmed to, prior to executing the instruction to follow the leader vehicle: transmit a follow request to a plurality of target vehicles; receive a plurality of responses from the respective plurality of target vehicles; and select the leader vehicle based on predetermined route data included within at least one of the plurality of responses.

5. The computer of claim 1, wherein, in response to detecting the abnormal driving action, the computer further is programmed to transmit a follow request to a plurality of target vehicles, select a new leader vehicle based on a response to the follow request, and instruct the host vehicle to follow the new leader vehicle.

6. The computer of claim 1, wherein monitoring the driving behavior further comprises monitoring, at the host vehicle, whether the leader vehicle follows a predetermined route provided previously by the leader vehicle, wherein the abnormal driving action includes a routing deviation from the predetermined route.

7. The computer of claim 1, wherein monitoring the driving behavior further comprises monitoring, at the host vehicle, whether the leader vehicle follows a predetermined route provided previously by the leader vehicle, wherein the abnormal driving action includes a routing deviation from the predetermined route greater than a predetermined threshold.

8. The computer of claim 1, wherein the computer further is programmed to, after executing the instruction to cease following the leader vehicle, instruct the host vehicle, in an autonomous mode, to PARK.

9. The computer of claim 1, wherein the computer further is programmed to, after monitoring the driving behavior of the leader vehicle, provide a notification to a driver of the host vehicle to disable an autonomous towing mode at the host vehicle while the host vehicle is moving.

10. The computer of claim 1, wherein the computer further is programmed to determine that the host vehicle has reached a predetermined destination, and based on the determination, instruct the host vehicle to PARK.

11. The computer of claim 1, wherein the computer further is programmed to determine that the host vehicle is approaching a predetermined destination, and based on the determination, provide a notification to a driver of the host vehicle to disable an autonomous towing mode at the host vehicle.

12. A computer, programmed to:
instruct a host vehicle to follow a first vehicle in an autonomous towing mode;
broadcast a follow request while following the first vehicle; and
based on receiving a response to the follow request from a second vehicle, instruct the host vehicle to follow the second vehicle in the autonomous towing mode.

13. The computer of claim 12, wherein the computer further is programmed to, prior to executing the instruction to follow the first vehicle: transmit an earlier follow request to a plurality of target vehicles; and select the first vehicle from among the plurality of target vehicles based on receiving a response to the earlier follow request.

14. The computer of claim 12, wherein the computer further is programmed to: store a host vehicle destination and store a first predetermined route provided to the host vehicle by the first vehicle, wherein the first predetermined route, when at least partially followed by the host vehicle, advances the host vehicle toward the destination.

15. The computer of claim 14, wherein the computer further is programmed to instruct the host vehicle to follow the second vehicle based on a second predetermined route provided to the host vehicle by the second vehicle, wherein the second predetermined route, when at least partially followed by the host vehicle: advances the host vehicle closer to the destination than continuing to follow the first predetermined route, advances the host vehicle more expeditiously toward the destination than by at least partially following the first predetermined route, or both.

16. The computer of claim 12, wherein the computer further is programmed to determine an abnormal driving action of the first vehicle, and in response to determining the abnormal driving action do at least one of the following: select a third vehicle and instruct the host vehicle to follow the third vehicle in the autonomous towing mode; instruct the host vehicle to PARK; or handover at least some vehicle control of the host vehicle to a user.

17. The computer of claim 12, wherein the computer further is programmed to determine an abnormal driving action of the first vehicle, wherein abnormal driving action includes a routing deviation from a predetermined route previously provided by the first vehicle that is greater than a predetermined threshold.

18. The computer of claim 12, wherein the computer further is programmed to determine that the host vehicle has reached a predetermined destination, and based on the determination, instruct the host vehicle to PARK.

19. The computer of claim 12, wherein the computer further is programmed to determine that the host vehicle is approaching a predetermined destination, and based on the determination, provide a notification to a driver of the host vehicle to disable an autonomous towing mode at the host vehicle.

20. The computer of claim 12, wherein the response includes a plurality of criteria that include: predetermined route data of the second vehicle, proximity data of the second vehicle, driver qualification data associated with the second vehicle, and fare data associated with the second vehicle, wherein the instruction to follow the second vehicle is based on at least one of the plurality of criteria.
